(19) United States
(12) Patent Application Publication
(10) Pub. No.: US 2007/0046212 A1
(43) Pub. Date: Mar. 1, 2007

(54) Flat panel display device and manufacturing method thereof

(76) Inventors: Hyea-Weon Shin, Yongin-si (KR); Yong-Seog Kim, Seoul (KR)

Correspondence Address: CHRISTIE, PARKER & HALE, LLP, PO BOX 7068, PASADENA, CA, 91109-7068, US

(21) Appl. No.: 11/513,865

(22) Filed: Aug. 30, 2006

(30) Foreign Application Priority Data
Aug. 31, 2005 (KR) 10-2005-0080645

(51) Int. Cl. H01J 17/49

(52) U.S. Cl. 313/586

(57) ABSTRACT

The flat panel display device of the present invention includes first and second substrates arranged opposite to each other; barrier ribs disposed between the first and second substrates; a phosphor layer disposed in a discharge space; address electrodes disposed on the second substrate along one direction; a second dielectric layer covering the address electrodes on the second substrate; at least a pair of display electrodes disposed on the first substrate in a direction crossing the address electrodes and arranged opposite to each other in the discharge space; and a first dielectric layer covering the display electrodes on the first substrate. Herein, an electron amplification layer including an electron amplifying material selected from the group consisting of ZnO, Al₂O₃, SiC, diamond, and combinations thereof is disposed on the first dielectric layer, and the electron amplifying material has a nanorod shape grown toward the discharge space.

### CROSS-REFERENCE TO RELATED APPLICATION

This application claims priority to and the benefit of Korean Patent Application No. 10-2005-0080645, filed in the Korean Intellectual Property Office on Aug. 31, 2005, the entire content of which is incorporated herein by reference.

### FIELD OF THE INVENTION

The present invention relates to a flat panel display device with high brightness characteristics and luminous efficiency, and low discharge voltages, and a method of manufacturing the same.

### BACKGROUND OF THE INVENTION

A plasma display panel (PDP) is a flat panel display device that forms images by using red (R), green (G), and blue (B) visible lights that are generated as vacuum ultra-violet (VUV) rays radiated from plasma obtained through gas discharge excite phosphors.

A PDP that is thinner than 10 cm can realize an ultra-large screen of more than 60 inches. In addition, since a PDP is a self-light-emitting display device like a cathode ray tube (CRT), it does not have a screen distortion phenomenon in which the screen is distorted according to a view angle, and it has a good color reproducibility characteristic. Also, since the manufacturing process of a PDP is simple compared to that of a liquid crystal display (LCD), it has been spotlighted for use as a television (TV) and/or an industrial flat panel display device with advantages with respect to productivity and production costs.

To increase its brightness, a PDP can increase its secondary electron emission quantity when ions separated by plasma collide with each other in a discharge space. To this end, researchers are developing technologies using carbon nanotubes.

### SUMMARY OF THE INVENTION

An aspect of the present invention provides a flat panel display device with high brightness characteristics and low driving voltages.

Another aspect of the present invention provides a method for manufacturing the flat panel display device with the high brightness characteristics and low driving voltages.

According to an embodiment of the present invention, a flat panel display device is provided. The flat panel display device includes: a first substrate and a second substrate arranged opposite to each other; a plurality of barrier ribs disposed in a gap between the first substrate and the second substrate and adapted to divide a discharge space to form a plurality of partitioned discharge spaces; a phosphor layer disposed inside the partitioned discharge spaces; a plurality of address electrodes disposed on the second substrate along a first direction; a second dielectric layer covering the address electrodes on the second substrate; at least a pair of display electrodes disposed on the first substrate along a second direction crossing the first direction of the address electrodes and arranged opposite to each other in each of the partitioned discharge spaces; and a first dielectric layer covering the display electrodes on the first substrate, wherein an electron amplification layer including an electron amplifying material selected from the group consisting of ZnO, Al₂O₃, SiC, diamond, and combinations thereof is disposed on the first dielectric layer, and wherein the electron amplifying material has a nanorod shape disposed toward the discharge space.

The flat panel display device may be a plasma display panel (PDP).

The electron amplification layer may be disposed on the entire surface of the first dielectric layer, or in areas corresponding to where the display electrodes are disposed.

The electron amplification layer may be disposed by planting the electron amplifying material on the first dielectric layer and/or growing it toward the discharge space.

The flat panel display device may further include at least one protection layer selected from the group consisting of fluoride layers and oxide layers on the electron amplification layer, and the protection layer may include at least one material selected from the group consisting of MgF₂, CaF₂, LiF, Al₂O₃, MgO, ZnO, CaO, SrO, SiO₂, La₂O₃, and combinations thereof.

When the electron amplification layer is disposed in areas corresponding to the areas where the display electrodes are disposed, the protection layer may be disposed on the entire surface of the first dielectric layer with the electron amplification layer disposed therein.

According to another embodiment of the present invention, a method for manufacturing a flat panel display device is provided. The method includes: forming a plurality of display electrodes on a first substrate; forming a first dielectric layer to cover the display electrodes on the first substrate; forming an electron amplification layer by disposing an electron amplifying material selected from the group consisting of ZnO, Al₂O₃, SiC, diamond, and combinations thereof on the first dielectric layer; forming a plurality of address electrodes on a second substrate; forming a second dielectric layer to cover the address electrodes on the second substrate; forming a plurality of barrier ribs between the address electrodes to partition a discharge space to form a plurality of partitioned discharge spaces on the second dielectric layer; forming a phosphor layer in the partitioned discharge spaces; facing the first substrate and the second substrate to each other; exhausting air between the first substrate and the second substrate; and sealing the first substrate and the second substrate together.

The electron amplifying material may be planted on the first dielectric layer.

The flat panel manufacturing method may further include forming at least one protection layer selected from the group consisting of a fluoride layer, an oxide layer and combinations thereof (e.g., on the electron amplifying layer).

### BRIEF DESCRIPTION OF THE DRAWINGS

FIG. 1 is a perspective view showing a flat panel display device in accordance with an embodiment of the present invention;

FIG. 2 is a cross-sectional view taken along the line II-II of FIG. 1;

FIG. 3 is a photograph showing a needle structure of ZnO, which is one of the electron amplifying materials in accordance with an embodiment of the present invention;

FIGS. 4A, 4B, 4C, 4D, 4E, 4G, 4H, and 4I are photographs showing an example of patterning of ZnO in accordance with an embodiment of the present invention; and

FIG. 5 is a graph presenting a result obtained by measuring brightness characteristics of flat panel display devices of Example 1 and Comparative Example 1, respectively.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

A flat panel display device, such as a PDP, displays images by performing a discharge in a plasma discharge space formed by barrier ribs on substrates.

During the process, a protection layer including MgO emits secondary electrons into the discharge space to increase efficiency of the flat panel display device. By doing so, it reduces a discharge voltage applied between electrodes and protects the electrodes inside the flat panel display device (or a panel of the flat panel display device).

However, protection layers used in current flat panel display devices have a low secondary electron emission coefficient, which leads to a low secondary electron amplification rate, increased voltage, and low brightness.

To improve the brightness by increasing the secondary electron emission quantity when ions separated by plasma collide with each other in a discharge space of a PDP, carbon nanotubes are used.

Carbon nanotubes have a high aspect ratio, a length of several microns (μm) with a diameter of several nanometers (nm), and both metal and semiconductor properties. Thus, an electric field tends to concentrate on line ends of the carbon nanotubes.

Also, carbon nanotubes have low resistance, and the low resistance induces many electrons to be emitted. Thus, even though a low operation voltage is applied to the electrodes, a great deal of plasma discharge is obtained just as if a high electric field is applied, and the formed discharge can be easily stabilized.

Also, carbon nanotubes have high mechanical strength, high chemical tolerance, and a long lifespan.

As described above, when a secondary electron amplification mechanism, such as carbon nanotubes, is applied to a PDP, the coefficient of secondary electron emission caused by ions in the PDP is increased. Thus, the PDP can acquire high brightness characteristics and high light-emitting efficiency and have a reduced discharge voltage, specifically, a reduced address voltage. Accordingly, it is possible to reduce power consumption and driving voltage of a driver integrated circuit (IC), and this allows the PDP to use an inexpensive low-power IC. Eventually, this type of secondary electron amplification mechanism should make it possible to manufacture a flat panel display device at a low cost.

However, since the carbon nanotubes are easily oxidized during panel planting, the carbon nanotubes should be baked in a nitrogen atmosphere to prevent oxidization thereof. Also, since carbon nanotubes are not easily dispersed, they may have to be planted in lumps. This causes an electric field to be partially concentrated and degrades discharge uniformity.

In view of the issues discussed above, an embodiment of the present invention uses an electron amplification material that is selected from the group consisting of ZnO, Al₂O₃, SiC, diamond, and combinations thereof. The use of this electron amplification material makes it easier to manufacture flat panel display devices, to maximize electron emission into the discharge space, to increase brightness and efficiency of the flat panel display devices, and to reduce the discharge sustain voltage.

In short, a flat panel display device in accordance with an embodiment of the present invention includes: a first substrate and a second substrate arranged opposite to each other; barrier ribs partitioning one or more discharge spaces between the first substrate and the second substrate; a phosphor layer disposed inside each of the partitioned discharge spaces; address electrodes disposed on the second substrate along a first direction; a second dielectric layer disposed on the second substrate to cover the address electrodes; display electrodes disposed on the first substrate along a second direction crossing the first direction of the address electrodes, where at least a pair of the display electrodes are disposed facing each other in each of the partitioned discharge spaces; and a first dielectric layer disposed on the first substrate to cover the display electrodes, wherein an electron amplification layer includes an electron amplifying material selected from the group consisting of ZnO, Al₂O₃, SiC, diamond, and combinations thereof, and the electron amplifying material has a shape of a nanorod disposed toward the discharge spaces.

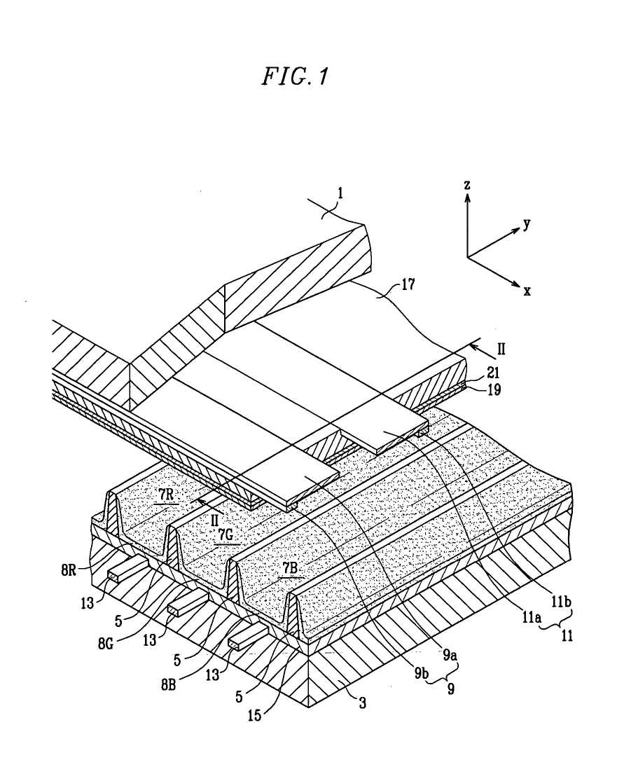

FIG. 1 is an exploded perspective view showing a flat panel display device in accordance with an embodiment of the present invention.

Referring to FIG. 1, the flat panel display device includes a first substrate (which can also be referred to as a front substrate) 1, a second substrate (which can also be referred to as a rear substrate) 3 facing the front substrate 1, and a discharge gas filled in a space between the front substrate 1 and the rear substrate 3.

A plurality of barrier ribs 5 are arranged in the space between the front substrate 1 and the rear substrate 3 to thereby form a plurality of partitioned discharge spaces 7R, 7G, and 7B. The discharge spaces 7R, 7G, and 7B include red (R), green (G), and blue (B) phosphors.

Display electrodes 9 and 11 are disposed along an x-axis direction with (or on) the front substrate 1, and the display electrodes 9 and 11 are positioned at an interval corresponding to the partitioned-discharge spaces 7R, 7G, and 7B along a y-axis direction.

Address electrodes 13 are disposed on the rear substrate 3 along the y-axis direction of FIG. 1 to cross (or cross over) the display electrodes 9 and 11, and the address electrodes 13 are positioned at an interval corresponding to the partitioned discharge spaces 7R, 7G, and 7B along the x-axis direction of FIG. 1.

The display electrodes 9 and 11 and the address electrodes 13 are arranged such that they cross over each other at regions corresponding to the partitioned discharge spaces 7R, 7G, and 7B.

The barrier ribs 5 disposed between the front substrate 1 and the rear substrate 3 are arranged in parallel to each other, and the front substrate 1 and the rear substrate 3 are arranged with a gap (or a predetermined space) therebetween to thereby form the partitioned discharge spaces 7R, 7G, and 7B, which are needed for discharge, in the gap.

Although FIG. 1 shows stripe-type barrier ribs 5 having a trip-type barrier rib structure disposed along a direction parallel to the address electrodes 13, which is the y-axis direction of FIG. 1, the barrier rib structure of the present invention is not thereby limited.

According to the embodiment of the present invention, the barrier rib structure may be a closed-type barrier rib structure where the discharge space is independently closed-off and partitioned by first barrier ribs (e.g., barrier ribs 5) disposed in parallel to address electrodes (i.e., the y-axis direction in FIG. 1) and second barrier ribs (not shown) disposed along a direction crossing the first barrier ribs (i.e., the x-axis direction in FIG. 1) to thereby form the partitioned discharge spaces 7R, 7G, and 7B. In addition, the barrier rib structure may be a closed-type barrier rib structure having the partitioned discharge spaces (e.g., the discharge spaces 7R, 7G, and 7B) in the shape of a square, a hexagon, or an octagon.

In FIG. 1, the address electrodes 13 are typically disposed on the rear substrate 3, and the present embodiment shows an example thereof. However, the present invention is not limited to this structure, and it may include structures where the address electrodes 13 are disposed with (or on) the front substrate 1 or the barrier ribs 5.

The address electrodes 13 are covered with a second dielectric layer 15 to form wall charges in the partitioned discharge spaces 7R, 7G, and 7B and cause address discharges, and the barrier ribs 5 are disposed on the second dielectric layer 15.

The display electrodes 9 and 11 are formed by sustain and scan electrodes 9 and 11 that face each other on both sides of the partitioned discharge spaces 7R, 7G, and 7B on the front substrate 1.

The present embodiment exemplifies a structure where the sustain and scan electrodes 9 and 11 are disposed on the front substrate 1 to face each other. However, the present invention may also have a structure where an inter-electrode (not shown) is additionally provided between the sustain and scan electrodes 9 and 11.

As illustrated in FIG. 1, the sustain and scan electrodes 9 and 11 may be composed of transparent electrodes 9a and 11a and bus electrodes 9b and 11b, respectively, or they may be formed of only the transparent electrodes 9a and 11a or bus electrodes 9b and 11b.

When the inter-electrode (not shown) is provided, it is desirable to form the inter-electrode of the same material as the sustain and scan electrodes 9 and 11 to simplify the manufacturing process.

The transparent electrodes 9a and 11a may be formed as stripes extending along a direction crossing the address electrodes 13, that is, the x-axis direction.

Also, the transparent electrodes 9a and 11a are where surface discharge occurs in the partitioned discharge spaces 7R, 7G, and 7B. Since the transparent electrodes 9a and 11a occupy a considerable area of the discharge spaces 7R, 7G, and 7B, it is desirable to form them with a transparent material to minimize the blocking of visible light and to secure high brightness. According to one embodiment, the transparent electrodes 9a and 11a are formed of indium tin oxide (ITO).

The bus electrodes 9b and 11b are used to ensure a level of electroconductivity of the electrodes 9 and 11 by compensating for the high resistance of the transparent electrodes 9a and 11a. In one embodiment, the bus electrodes 9b and 11b are formed of a metal having high electroconductivity, and, in one embodiment, they are formed of aluminum (Al).

The bus electrodes 9b and 11b are stacked with (or on top of) the transparent electrodes 9a and 11a disposed on the front substrate 1 in a direction crossing the address electrodes 13, which is the x-axis direction in FIG. 1.

Also, since the bus electrodes 9b and 11b are formed of an opaque material, it is desirable to form the bus electrodes 9b and 11b at positions corresponding to the barrier ribs 5 in a width narrower than the width of the barrier ribs 5 to minimize the blocking of the visible light emitted in the discharge spaces 7R, 7G, and 7B.

The display electrodes 9 and 11 disposed as described above are covered with a first dielectric layer 17 to accumulate wall charges.

The first dielectric layer 17 may be formed of a transparent dielectric substance to improve permeability of the visible light.

Also, an electron amplification layer 21 including a nanorod-type electron amplifying material disposed toward the discharge space is disposed on the first dielectric layer 17.

The electron amplification layer 21 may be exposed to the discharge space to let secondary electrons easily separate into the discharge space.

Accordingly, the electron amplification layer may be disposed on the entire surface of the first dielectric layer 17, or it may be disposed on the first dielectric layer 17 in areas corresponding to areas where the display electrodes are disposed. The electron amplification layer may be disposed in a particular pattern on the first dielectric layer 17.

Also, the electron amplification layer may be disposed to be interposed between an upper dielectric layer and a lower dielectric layer of the first dielectric layer, which has a double layer structure.

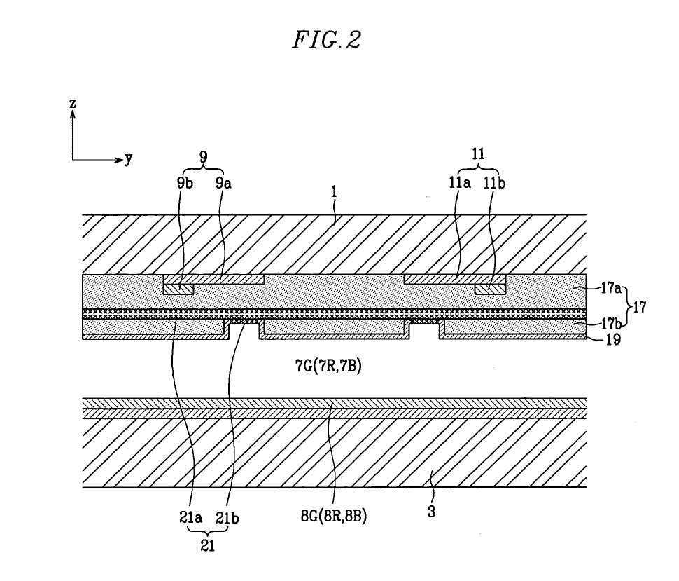

The pattern of the electron amplification layer 21 can be obtained by patterning the first dielectric layer 17. FIG. 2 is a cross-sectional view taken along the line II-II of FIG. 1.

Referring to FIG. 2, the first dielectric layer 17 includes a third dielectric layer 17a and a fourth dielectric layer 17b, and the electron amplification layer 21 is interposed therebetween. That is, the third dielectric layer 17a is disposed on the display electrodes 9 and 11, and the electron amplification layer 21 is formed on the third dielectric layer 17a. Then, the fourth dielectric layer 17b is disposed on the electron amplification layer 21 by patterning such that a portion of the electron amplification layer 21 is exposed. Accordingly, the electron amplification layer 21 is formed on the entire surface of the third dielectric layer 17a, and the fourth dielectric layer 17b having an opening pattern is formed on the electron amplification layer 21.

That is, according to the pattern of the fourth dielectric layer 17b, the electron amplification layer 21 has portions 21a that are covered with the fourth dielectric layer 17b, and other portions 21b that are exposed from the fourth dielectric layer 17b through the opening pattern of the fourth dielectric layer 17b. In one embodiment, the other portions 21b that are exposed have the same thickness as the portions 21a that are covered. Alternatively, as shown in FIG. 2, the other portions 21b that are exposed are formed to be thicker than the portions 21a that are covered (e.g., the other portions 21b may be thicker because the other portions 21b may be extended into a protection layer 19). As described above, the exposed portions 21b may be formed so as to correspond to end-portions of the display electrodes 9 and 11 disposed closer to the center of the discharge cell 7G (7R, 7B) in order to increase the emission amount of secondary electrons and to perform low-voltage driving. That is, the exposed portions 21b of the electron amplification layer 21 are disposed to correspond to end portions of the transparent electrodes 9a and 11a opposite to each other.

The electron amplification layer 21 does not hinder emission of visible light and addressing between the address electrodes 13 and any one electrode (typically, a scan electrode) among the sustain and scan electrodes 9 and 11. The electron amplification layer 21 improves brightness by increasing the secondary electron emission quantity to thereby improve a ratio between consumption power and brightness, that is, efficiency.

The electron amplification layer may be formed by growing an electron amplifying material in the first dielectric layer toward the discharge space. Alternatively, in one embodiment, the electron amplifying material may be formed on the first dielectric layer by a planting method (or by planting).

The electron amplifying material may be formed by using a material selected from the group consisting of ZnO, Al₂O₃, SiC, diamond (C), and combinations thereof, and, in one embodiment, may be formed of ZnO.

The electron amplifying material, such as ZnO, Al₂O₃, and SiC, has a needle structure similar to carbon nanotubes, and this needle structure can be grown more easily than carbon nanotubes.

As shown above, when the electron amplifying material has a needle structure, the electric field may concentrate at the line end of the electron amplifying material to thereby effectively reduce the discharge voltage.

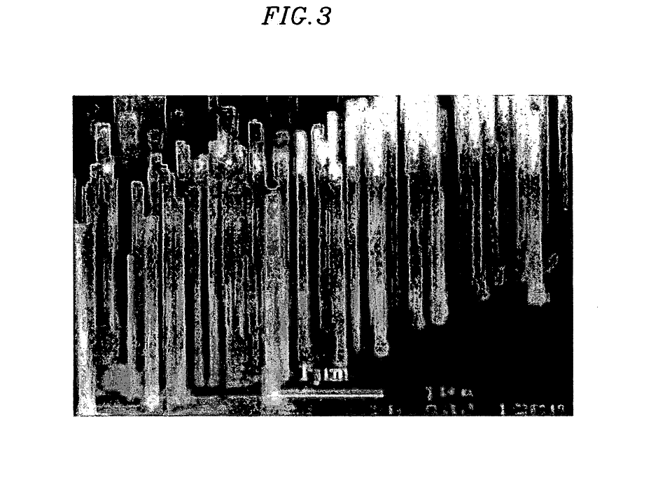

FIG. 3 is a scanning electron microscope (SEM) photograph showing ZnO having a nanorod shape in accordance with an embodiment of the present invention. As shown in FIG. 3, the ZnO nanorod has a needle structure.

Since the electron amplifying materials have a high degree of shape freedom, they can be diversely patterned to form a plurality of patterns.

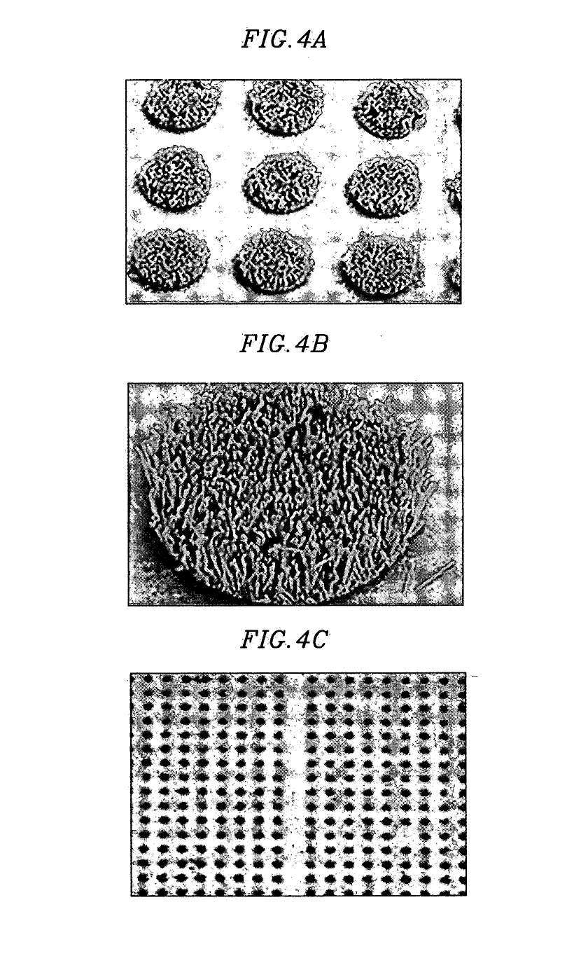

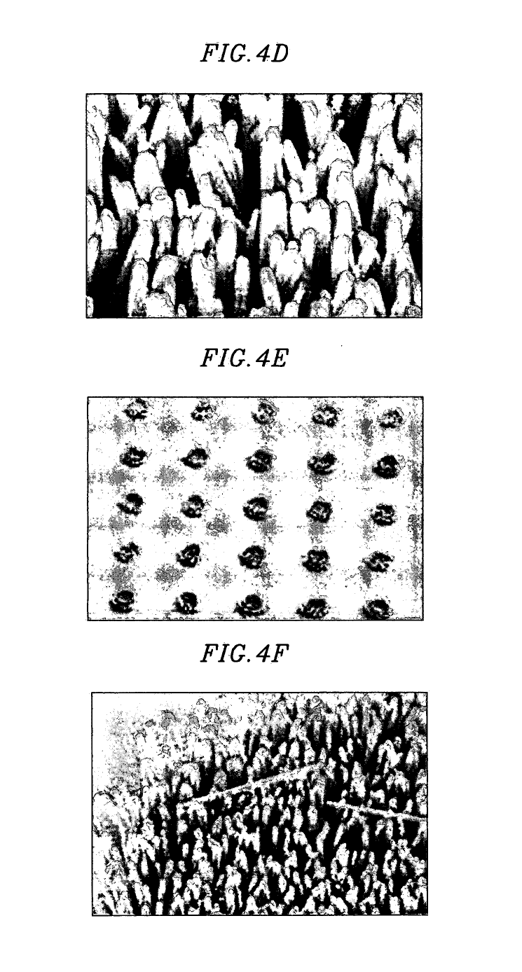

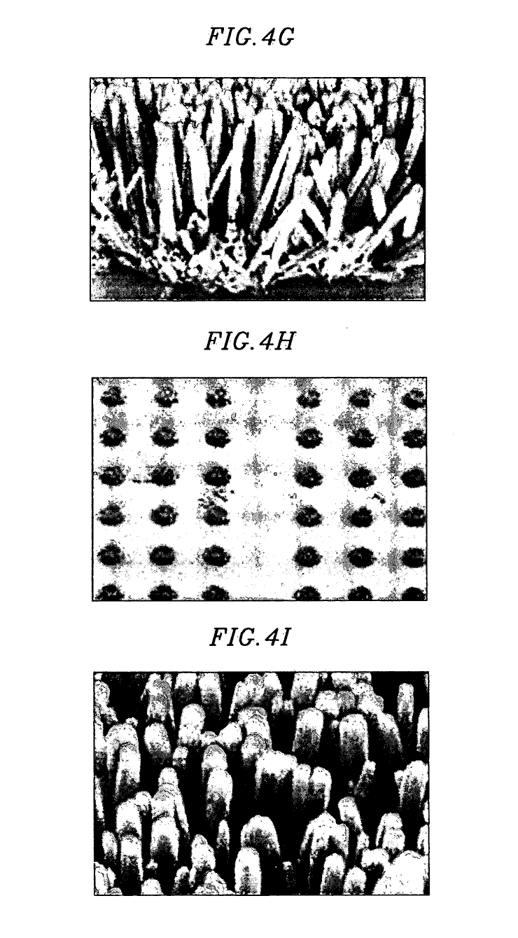

FIGS. 4A to 41 are photographs showing an example of ZnO patterning with different magnifications.

FIGS. 4A to 41 are pictures of the same ZnO patterning with magnifications of 2000-fold, 8000-fold, 180-fold, 50,000-fold, 600-fold, 20,000-fold, 18,000-fold, 500-fold and 50,000-fold, respectively.

The electron amplifying materials are coated with at least one material selected from the group consisting of fluoride, oxide, and combinations thereof to be protected from oxidization during discharge.

To be specific, the coating material may be coated with at least one material selected from the group consisting of MgO, MgF₂, CaF₂, LiF, Al₂O₃, ZnO, CaO, SrO, SiO₂, La₂O₃, and combinations thereof.

In one embodiment, the electron amplifying material is included in a ratio ranging from 1 to 40 wt % of the entire weight of the electron amplification layer, and, in one embodiment, it is included in a ratio ranging from 5 to 30 wt %. Within these content ranges, it is possible to obtain high brightness, improved efficiency, and reduced discharge sustain voltage. With ratios that are above or below these content ranges, however, the electron amplification effect is insignificant or uneconomical.

The flat panel display device suggested in the embodiment of the present invention may further include at least one layer selected from the group consisting of a fluoride layer, an oxide layer, and combinations thereof, on top of the electron amplification layer.

In one embodiment as shown in FIG. 2, the flat panel display device may further include at least one layer of a protection layer 19 formed using at least one material selected from the group consisting of MgO, MgF₂, CaF₂, LiF, Al₂O₃, ZnO, CaO, SrO, SiO₂, La₂O₃, and combinations thereof.

The protection layer 19 prevents the ions of separated atoms from colliding with and damaging the first dielectric layer 17, and it efficiently emits secondary electrons when the ions collide with it.

As such and in view of the foregoing, when a voltage higher than a discharge initiation voltage is applied to the space between the scan electrode and the sustain electrode disposed in parallel to each other along a direction crossing the address electrodes, the flat panel display device in accordance with an embodiment of the present invention can emit a large number of secondary electrons when surface discharge occurs in the discharge space.

This signifies that a large amount of plasma discharge occurs in the discharge space, as the voltage is applied between the scan electrode and the sustain electrode.

This also means that a discharge gas injected into the discharge space is ionized to a greater degree at the same applied voltage.

Thus, more ultraviolet rays are emitted from the discharge space, and since the ultraviolet rays are used to excite the phosphor layer, more lights are emitted from the phosphor layer than in the conventional technologies.

Therefore, brightness of images is improved.

The flat panel display device suggested in the present embodiment may be a plasma display panel (PDP).

In accordance with an embodiment of the present invention, the flat panel display device is manufactured by forming a plurality of display electrodes on a first substrate; forming a first dielectric layer to cover the display electrodes on the first substrate; forming an electron amplification layer by disposing an electron amplifying material selected from the group consisting of ZnO, Al₂O₃, SiC, diamond, and combinations thereof on the first dielectric layer; forming a plurality of address electrodes on a second substrate; forming a second dielectric layer to cover the address electrodes on the second substrate; forming a plurality of barrier ribs between the address electrodes to partition a discharge space to form a plurality of partitioned discharge spaces on the second dielectric layer; forming a phosphor layer in the partitioned discharge spaces; facing the first substrate and the second substrate to each other; exhausting air between the first substrate and the second substrate; and sealing the first substrate and the second substrate together.

Except for the method of forming the electron amplification layer, a detailed description of the flat panel display device manufacturing method will not be provided again in more detail. The following method is only provided as an embodiment of the present invention, and the present invention is not limited to this embodiment.

Initially, in the present method, the display electrodes that are formed of a transparent electrode and a bus electrode are disposed on the first substrate, and then the first dielectric layer is disposed on the display electrodes. The first dielectric layer may be formed by a method known those skilled in the art, and the first dielectric layer is, in one embodiment, formed to have a thickness ranging from 10 to 20 Sn.

Subsequently, the electron amplification layer is formed by growing an electron amplifying material toward the discharge space on the first dielectric layer.

Alternatively, the electron amplification layer may be formed by using a planting method.

Herein, the electron amplifying material may be planted on the entire surface of the first dielectric layer, or it may be planted on the first dielectric layer in areas corresponding to the areas where the display electrodes are disposed.

The planting process may be carried out by a method known to those skilled in the art. In one embodiment, the planting is performed on the first dielectric layer by spraying the electron amplifying material or by dripping the electron amplifying material with a pipette.

There are no specific limits in temperature and time for the planting process. However, in one embodiment, the content of the electron amplifying material in the electron amplification layer ranges from 1 wt % to 40 wt %. In one embodiment, the content of the electron amplifying material ranges from 5 wt % to 30 wt %.

The electron amplifying material may be formed by using a material selected from the group consisting of ZnO, Al₂O₃, SiC, diamond (C), and combinations thereof, and, in one embodiment, may be formed of ZnO.

Optionally, at least one protection layer selected from the group consisting of a fluoride layer, an oxide layer, and combinations thereof may be additionally from on top of the electron amplification layer.

To be specific, it is possible to additionally form at least one protection layer selected from the group consisting of fluoride layers including MgF₂, CaF₂, and LiF, and oxide layers including MgO, Al₂O₃, ZnO, CaO, SrO, SiO₂, and La₂O₃.

The protection layer forming method is not specifically limited. It may be formed by a thick layer printing method using a paste, or by a plasma deposition method. In one embodiment, the deposition method is used because it is relatively strong against sputtering based on ion impact, and it can reduce the discharge initiating voltage and the discharge sustain voltage by the emission of secondary electrons.

Methods of forming the protection layer using the plasma deposition method include a magnetron sputtering method, an electron beam deposition method, an Ion Beam Assisted Deposition (IBAD) method, a Chemical Vapor Deposition (CVD) method, a sol-gel method, and an ion plating method. The ion plating method forms a layer by ionizing vaporized particles. The ion plating method has similar characteristics to the sputtering method with respect to adherence and crystallization of the protection layer but it has an advantage that it can perform deposition at a high speed of 8 nm/s. Among the methods for forming the protection layer, one embodiment uses the electron beam deposition method.

When the flat panel display device including a secondary electron amplification mechanism having nanorod-type ZnO, Al₂O₃, and/or SiC in the discharge space is used, the electron amplification layer can be easily formed (without the difficulties associated with oxidizing and dispersing of carbon nanotubes) to increase an electron density in the discharge space by raising a secondary electron emission coefficient of ions inside of the flat panel display device, to provide the electrons required for glow discharge, and to improve discharge characteristics and brightness characteristics by changing a discharge mode.

The following examples illustrate the present invention in more detail. However, it is understood that the present invention is not limited by these examples.

### EXAMPLE 1

Display electrodes were formed of an indium tin oxide conductive material in the shape of stripes on a first substrate that was formed of soda lime glass by using a method known to those skilled in the art.

Subsequently, the entire surface of the first substrate, including the display electrodes, was coated with a dielectric paste that was formed of 28.4 wt % SiO₂, 69.8 wt % PbO, and 1.8 wt % B₂O₃ and baked to thereby form a first dielectric layer.

Then, 20 wt % of ZnO nanorod was planted on the first dielectric layer to thereby form an electron amplification layer.

The resultant structure was put into a protection layer deposition chamber, and a protection layer including MgO was deposited using an ion plating method to thereby complete the formation of the first substrate.

The protection layer deposition chamber was controlled to have a regular pressure level of 1×10⁻⁴ Pa and an operation pressure level of 5.3×10⁻² Pa during the deposition. The protection layer deposition chamber was further controlled to sustain the substrate at 200±5° C. by supplying oxygen at 100 sccm.

Subsequently, address electrodes, a second dielectric layer, barrier ribs, and a phosphor layer were disposed on a second substrate. Then, the second substrate was brought to face the first substrate, and air was exhausted out of a discharge space between the first substrate and the second substrate. A discharge gas was injected into the discharge space at the condition of 400 Torr to thereby form a plasma display panel (PDP).

### EXAMPLE 2

A plasma display panel was manufactured with substantially the same method as Example 1, except that the electron amplification layer was formed by using Al₂O₃ nanorod.

### COMPARATIVE EXAMPLE 1

A plasma display panel was manufactured with substantially the same method as the Example 1, except that the electron amplification layer was not formed.

### COMPARATIVE EXAMPLE 2

A plasma display panel was manufactured with substantially the same method as the Example 1, except that the electron amplification layer was formed by using carbon nanotubes instead of ZnO nanorod.

Only the green phosphor layers of the plasma display panels of Example 1 and Comparative Example 1 were turned on, and the brightness of the green light emitted from the plasma display panels was measured by using a contact-type brightness meter (CA-100) at 30 kHz during operation.

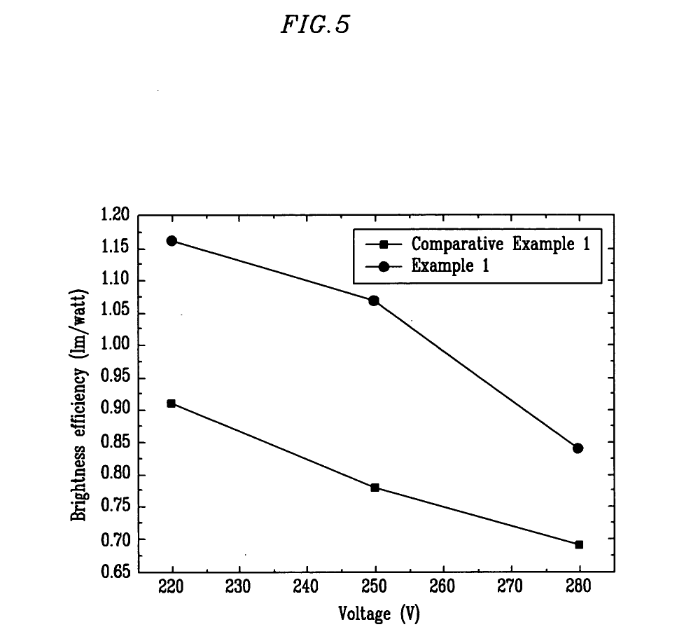

The measurement results are shown in FIG. 5.

As illustrated in FIG. 5, the plasma display panel of Example 1 that included the electron amplification layer showed superior brightness characteristics to the plasma display panel of Comparative Example 1 that did not include the electron amplification layer.

In view of the foregoing, a flat panel display device of one embodiment of the present invention can easily form an electron amplification layer (without the difficulties associated with oxidizing and dispersing of carbon nanotubes) to thereby increase an electron density by providing a sufficient amount of electrons required for high glow discharge by raising a secondary electron emission coefficient of ions inside of the flat panel display device, and improve the discharge characteristics and brightness characteristics remarkably by changing a discharge mode.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A flat panel display device comprising:
a first substrate and a second substrate arranged opposite to each other;
a plurality of barrier ribs disposed in a gap between the first substrate and the second substrate and adapted to divide a discharge space to form a plurality of partitioned discharge spaces;
a phosphor layer disposed inside the partitioned discharge spaces;
a plurality of address electrodes disposed on the second substrate along a first direction;
a second dielectric layer covering the address electrodes on the second substrate;
at least a pair of display electrodes disposed on the first substrate along a second direction crossing the first direction of the address electrodes and arranged opposite to each other in each of the partitioned discharge spaces; and
a first dielectric layer covering the display electrodes on the first substrate,
wherein an electron amplification layer including an electron amplifying material selected from the group consisting of ZnO, Al₂O₃, SiC, diamond, and combinations thereof is disposed on the first dielectric layer, and
wherein the electron amplifying material has a nanorod shape disposed toward the discharge space.

2. The flat panel display device of claim 1, wherein the electron amplification layer is disposed on the entire surface of the first dielectric layer.

3. The flat panel display device of claim 1, wherein the electron amplification layer is disposed on the first dielectric layer in areas corresponding to areas where the display electrodes are disposed.

4. The flat panel display device of claim 1, wherein the electron amplification layer is formed by planting the electron amplifying material on the first dielectric layer.

5. The flat panel display device of claim 1, wherein the electron amplification layer is formed by growing the electron amplifying material on the first dielectric layer.

6. The flat panel display device of claim 1, wherein the electron amplifying material is coated with at least one material selected from the group consisting of fluoride, oxide, and combinations thereof.

7. The flat panel display device of claim 1, wherein the electron amplification layer ranges from 1 to 40 wt % of the electron amplifying material with respect to the total weight of the electron amplification layer.

8. The flat panel display device of claim 1, further comprising at least one protection layer selected from the group consisting of a fluoride layer, an oxide layer, and combinations thereof on the electron amplification layer.

9. The flat panel display device of claim 8, wherein the protection layer includes at least one material selected from the group consisting of MgF₂, CaF₂, LiF, Al₂O₃, MgO, ZnO, CaO, SrO, SiO₂, La₂O₃, and combinations thereof.

10. The flat panel display device of claim 1, wherein the flat panel display device is a plasma display panel (PDP).

11. A method for manufacturing a flat panel display device, comprising:
forming a plurality of display electrodes on a first substrate;
forming a first dielectric layer to cover the display electrodes on the first substrate;
forming an electron amplification layer by disposing an electron amplifying material selected from the group consisting of ZnO, Al₂O₃, SiC, diamond, and combinations thereof on the first dielectric layer;
forming a plurality of address electrodes on a second substrate;
forming a second dielectric layer to cover the address electrodes on the second substrate;
forming a plurality of barrier ribs between the address electrodes to partition a discharge space to form a plurality of partitioned discharge spaces on the second dielectric layer;
forming a phosphor layer in the partitioned discharge spaces;
facing the first substrate and the second substrate to each other;
exhausting air between the first substrate and the second substrate; and
sealing the first substrate and the second substrate together.

12. The flat panel manufacturing method of claim 11, wherein the forming of the electron amplification layer by disposing the electron amplifying comprises planting the electron amplifying material on the first dielectric layer.

13. The flat panel manufacturing method of claim 11, wherein the forming of the electron amplification layer by disposing the electron amplifying comprises growing the electron amplifying material on the first dielectric layer.

14. The flat panel manufacturing method of claim 11, wherein a content of the electron amplifying material ranges from 1 to 40 wt % of the entire weight of the electron amplifying layer.

15. The flat panel manufacturing method of claim 11, further comprising:
forming at least one protection layer selected from the group consisting of a fluoride layer, an oxide layer, and combinations thereof.

16. The flat panel display device of claim 1, wherein the first dielectric layer comprises a second dielectric layer and a third dielectric layer, and wherein the electron amplification layer is between the second dielectric layer and the third dielectric layer.

17. The flat panel display device of claim 16, wherein the third dielectric layer comprises a plurality of openings to expose the electron amplification layer to the discharge space.
